(19) United States
(12) Patent Application Publication
(10) Pub. No.: US 2019/0392195 A1
(43) Pub. Date: Dec. 26, 2019

(54) ELECTRONIC APPARATUS AND OPERATING METHOD THEREOF

(71) Applicant: LG ELECTRONICS INC., Seoul (KR)

(72) Inventor: Ji Chan MAENG, Seoul (KR)

(73) Assignee: LG ELECTRONICS INC., Seoul (KR)

(21) Appl. No.: 16/559,431

(22) Filed: Sep. 3, 2019

(30) Foreign Application Priority Data
Jul. 15, 2019 (KR) 10-2019-0085374

(51) Int. Cl. G06K 9/00; G06F 3/01

(52) U.S. Cl. CPC G06K 9/00221; G06F 3/011; G06F 3/017; G06K 9/00335

(57) ABSTRACT

An electronic apparatus and an operating method thereof which execute a mounted artificial intelligence (AI) algorithm and/or machine learning algorithm and communicate with other electronic apparatuses and external servers in a 5G communication environment are disclosed. The electronic apparatus includes a camera, a display which displays predetermined contents, and a processor which recognizes at least one of a gaze, a facial expression, or a motion of the user by means of the camera, determines an interaction command for the user based on at least one of the recognized gaze, facial expression, or motion of the user, and performs the determined interaction command. Therefore, the user's convenience may be improved.

### CROSS-REFERENCE TO RELATED APPLICATION

Pursuant to 35 U.S.C. § 119(a), this application claims the benefit of earlier filing date and right of priority to Korean Patent Application No. 10-2019-0085374, filed on Jul. 15, 2019, the contents of which are hereby incorporated by reference herein in its entirety.

### BACKGROUND

### 1. Technical Field

The present disclosure relates to an electronic apparatus and an operating method thereof, and more particularly, to an electronic apparatus which is driven based on a reaction of a user and an operating method thereof.

### 2. Description of the Related Art

Electronic apparatuses which are mainly mounted with a semiconductor include a display device, a device mounted in a vehicle, a mobile device, a computer, a robot, and the like. In accordance with the development of technology, various electronic apparatuses which consider user's convenience, device stability, and efficiency are constantly appearing.

A multimedia device disclosed in the related art 1 recognizes a gesture of a user to provide a configuration menu based on the recognized user's gesture obtained by recognizing a user's gesture and when the recognition of the gesture fails, provide a guide message to recognize the gesture.

However, since the multimedia device recognizes only the gesture of the user and uses the recognized gesture only to set the configuration of the device, there is a limit in that it is difficult to recognize user's various reactions.

According to the related art 2, when a user approaches the electronic apparatus, the electronic apparatus tracks the motion of the user.

However, the electronic apparatus disclosed in the related art 2 only provides a method for accurately recognizing the motion of the user but cannot provide a user-friendly service which considers a user's gaze and a facial expression.

### Related Art Document

Related Art 1: Korean Patent Application Publication No. 10-2012-0051211 (Published on May 22, 2012)

Related Art 2: Korean Patent Application Publication No. 10-2012-0080070 (Published on Jul. 16, 2012)

### SUMMARY OF THE INVENTION

An object to be achieved by the present disclosure is to provide an electronic apparatus which performs a user-customized operation based on various reactions of a user who watches contents and an operating method thereof.

Another object to be achieved by the present disclosure is to provide an electronic apparatus which recognizes a user's gaze, a facial expression, and a motion to promptly figure out the user's needs and provide a service and an operating method thereof.

Still another object to be achieved by the present disclosure is to provide an electronic apparatus which figures out a position of a pedestrian and an obstacle located in a dead spot when a vehicle is driven, based on the reaction of the user and an operating method thereof.

Technical objects to be achieved in the present invention are not limited to the aforementioned technical objects, and another not-mentioned technical object will be obviously understood by those skilled in the art from the description below.

In order to achieve the above-described objects, an operating method of an electronic apparatus according to an exemplary embodiment of the present disclosure may perform an interaction operation for a user based on the reaction of the user.

Specifically, the operating method of an electronic apparatus may include: recognizing at least one of a gaze, a facial expression, or a motion of a user located in a photographic range of a camera; determining an interaction command for the user based on at least one of the recognized gaze, facial expression, or motion of the user; and performing the determined interaction command.

Further, the operating method may further include: recognizing the photographed user based on a previously stored recognition model.

Here, the determining of an interaction command may include: determining an interaction command for the user in accordance with a previously stored reaction model, based on at least one of the recognized gaze, facial expression, or motion of the user.

The operating method may further include: prior to the recognizing of at least one of a gaze, a facial expression, or a motion of the user, displaying predetermined contents.

In some exemplary embodiments, the recognizing may include: recognizing an eye frowned face of the user or a motion to approach the specific area when the gaze of the user is focused on the specific area of the contents for a predetermined time period.

Further, the determining of an interaction command may include: determining an interaction command to enlarge and display the specific area based on the recognized facial expression or motion.

In some exemplary embodiments, the recognizing may include: recognizing the motion of the user to indicate a specific area when the gaze of the user is focused on the specific area of the contents for a predetermined time period.

Further, the determining of an interaction command may include: determining an interaction command to display information related to the specific area based on the recognized motion.

The performing of the determined interaction command may include: dividing a display area into a plurality of separate areas when an interaction command to display information related to the specific area is determined; and displaying the contents in a first separate area and displaying the information related to the specific area in a second separate area.

The displaying of the information related to the specific area in a second separate area may include: displaying purchase information related to a product displayed in the specific area in the second separate area.

When the electronic apparatus is applied to a vehicle, the determining of an interaction command may include: photographing the outside of the vehicle corresponding to a front pillar area when the recognized gaze of the user is focused on the front pillar area in the vehicle for a predetermined time period; and determining an interaction command to display an image of the outside of the vehicle corresponding to the front pillar area in the front pillar area.

In order to achieve the above-described objects, an electronic apparatus according to an exemplary embodiment of the present disclosure may include: a camera, a display which displays predetermined contents, and a processor which recognizes at least one of a gaze, a facial expression, or a motion of the user by means of the camera, determines an interaction command for the user based on at least one of the recognized gaze, facial expression, or motion of the user, and performs the determined interaction command.

In order to achieve the above-described objects, an electronic apparatus mounted in a vehicle according to an exemplary embodiment of the present disclosure may include: a first camera which photographs a user located in the vehicle; a second camera which photographs the outside of the vehicle; and a processor which recognizes at least one of a gaze, a facial expression, or a motion of the user by means of the first camera, determines an interaction command based on at least one of the recognized gaze, facial expression, or motion of the user, and performs the determined interaction command, in which the processor may photograph the outside of the vehicle corresponding to a front pillar area using the second camera when the gaze of the user is focused on the front pillar area in the vehicle for a predetermined time period; and determine an interaction command to display an image of the outside of the vehicle corresponding to the front pillar area in the front pillar area.

According to various exemplary embodiments of the present disclosure, the following effects can be derived.

First, an electronic apparatus which performs a user-customized operation based on various reactions of a user who watches the contents to improve the user's convenience for usage of products.

Second, user's needs are promptly figured out and handled by the reaction of the user so that user's convenience is provided, and additional value may be provided to product usability.

Third, when the vehicle is driven, a position of a pedestrian or an obstacle disposed in a dead spot of a front side area of the vehicle is displayed by a simple motion of the user so that the user's convenience may be improved and the vehicle driving stability may be improved.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

The above and other aspects, features, and advantages of the present disclosure will become apparent from the detailed description of the following aspects in conjunction with the accompanying drawings, in which:

FIG. 1 is a schematic view for explaining a network environment in which one or more electronic apparatuses according to an exemplary embodiment of the present disclosure and one or more systems are connected to each other;

FIG. 2 is a block diagram illustrating a configuration of an electronic apparatus according to an exemplary embodiment of the present disclosure;

FIGS. 3 to 6 are views for explaining an operation of an electronic apparatus which performs an interaction with a user according to various exemplary embodiments of the present disclosure; and

FIG. 7 is a sequence diagram illustrating an operating method of an electronic apparatus according to an exemplary embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. Further, in describing the exemplary embodiment disclosed in the present specification, when it is determined that a detailed description of a related publicly known technology may obscure the gist of the exemplary embodiment disclosed in the present specification, the detailed description thereof will be omitted.

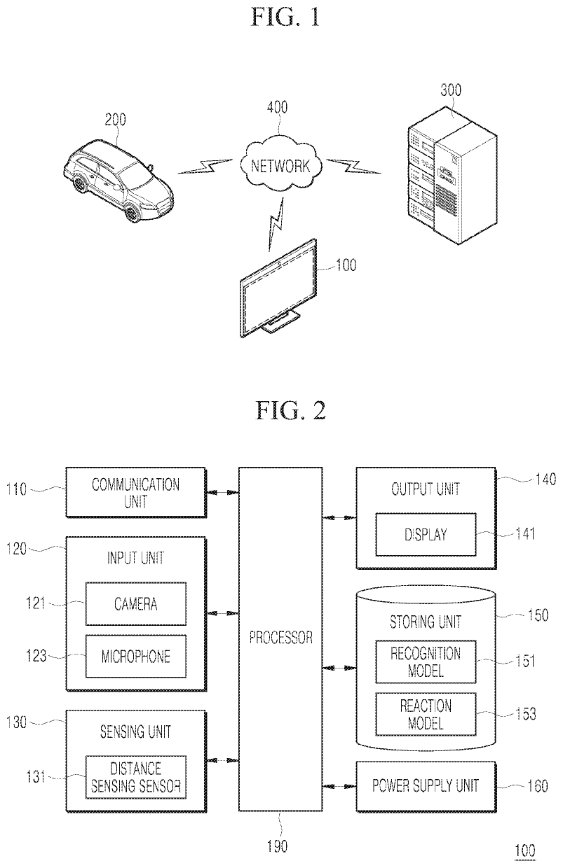

FIG. 1 is a schematic view for explaining an environment in which an electronic apparatus 100 according to an exemplary embodiment of the present disclosure, an electronic apparatus 200 mounted in a vehicle, and an external system 300 are connected to each other through a network 400.

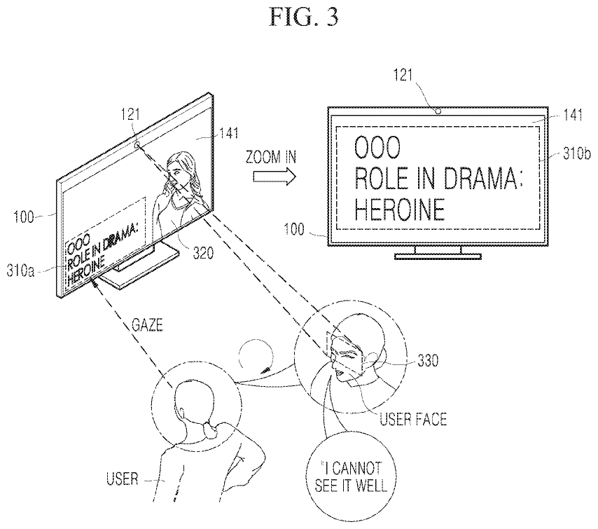

The electronic apparatus 100 may include a display device. As a selective embodiment, the electronic apparatus 100 may include a mobile terminal including a camera, a refrigerator, a computer, and a monitor. The electronic apparatus 100 includes a communication unit 110 (see FIG. 2) to communicate with the external system 300 through the network 400. Here, the external system 300 may include a system which performs a deep learning operation at a high speed and various servers/systems.

The electronic apparatus 200 mounted in the vehicle may include an electric control unit (ECU), an audio video navigation (AVN) module, a camera, a display, a projector, and the like and may communicate with the external system 300 through the network 400. Here, the external system 300 may include a system which performs a deep learning operation at a high speed, a telematics system, and a system which controls an autonomous vehicle.

The electronic apparatuses 100 and 200 and the external system 300 are mounted with 5G modules to transmit and receive data at a speed of 100 Mbps to 20 Gbps (or higher) and transmit a large capacity of video files to various devices and are driven with a low power so that the power consumption may be minimized.

Hereinafter, the configuration of the electronic apparatus 100 will be described with reference to FIG. 2.

The electronic apparatus 100 may include a communication unit 110, an input unit 120, a sensing unit 130, an output unit 140, a storing unit 150, a power supply unit 160, and a processor 190. Components illustrated in FIG. 2 are not essential for implementing the electronic apparatus 100 so that the electronic apparatus 100 described in this specification may include more components or fewer components than the above-described components.

First, the communication unit 110 is a module which performs communication between the electronic apparatus 100 and one or more communication devices. When the electronic apparatus 100 is disposed at a normal home, the electronic apparatus 100 may configure a home network with various communication devices (for example, a refrigerator, an internet protocol television (IPTV), a Bluetooth speaker, an artificial intelligence (AI) speaker, or a mobile terminal).

The communication unit 110 may include a mobile communication module and a short-range communication module. First, the mobile communication module may transmit and receive a wireless signal with at least one of a base station, an external terminal, or a server on a mobile communication network constructed in accordance with technical standards or communication schemes for the mobile communication (for example, global system for mobile communication (GSM), code division multi access (CDMA), CDMA2000, enhanced voice-data optimized or enhanced voice-data only (EV-DO), wideband CDMA (WCDMA), high speed downlink packet access (HSDPA), high speed uplink packet access (HSUPA), long term evolution (LTE), long term evolution advanced (LTE-A), or a 5G (generation)). Further, the communication unit 110 may include a short-range communication module. Here, the short-range communication module may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity Wi-Fi Direct, or Wireless Universal Serial Bus (USB) technologies.

Further, the communication unit 110 may support various kinds of object intelligence communications (such as Internet of things (IoT), Internet of everything (IoE), and Internet of small things (IoST)) and may support communications such as machine to machine (M2M) communication, vehicle to everything communication (V2X), and device to device (D2D) communication.

The input unit 120 may include a camera 121 or an image input unit which inputs an image signal, a microphone 123 or an audio input unit which inputs an audio signal, and a user input unit (for example, a touch key or a mechanical key) which receives information from a user. The input unit 120 may include a plurality of cameras 121 and a plurality of microphones 123. The camera 121 may photograph the user (for example, a user or an animal).

The sensing unit 130 may include one or more sensors which sense at least one of information in the electronic apparatus 100, surrounding environment information around the electronic apparatus 100, or user information. For example, the sensing unit 130 may include at least one of a distance sensing sensor 131 (for example, a proximity sensor, a passive infrared (PIR) sensor, or a Lidar sensor), a weight sensing sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, a camera 121), a microphone 123, a battery gauge, an environment sensor (for example, a barometer, a hygrometer, a thermometer, a radiation sensor, a thermal sensor, or a gas sensor), or a chemical sensor (for example, an electronic nose, a healthcare sensor, or a biometric sensor). In the meantime, the electronic apparatus 100 disclosed in the present specification may combine and utilize information sensed by at least two sensors from the above-mentioned sensors.

The output unit 140 is provided to generate outputs related to vision, auditory sense, or tactile sense and may include at least one of a display 141 (a plurality of displays can be implemented), a projector (a plurality of projectors can be implemented), one or more light emitting diodes, a sound output unit, or a haptic module.

Here, the display 141 may display a predetermined image and form a mutual layered structure with a touch sensor or may be formed integrally to be implemented as a touch screen. The touch screen may serve as a user input unit which provides an input interface between the electronic apparatus 100 and the user and as well as an output interface between the electronic apparatus 100 and the user.

The storing unit 150 stores data which supports various functions of the electronic apparatus 100. The storing unit 150 comprises at least one of a storage. The storing unit 150 may store a plurality of application programs (or applications) driven in the electronic apparatus 100, data for operations of the electronic apparatus 100, and commands. At least some of application programs may be downloaded from the external server through wireless communication. Further, the storing unit 150 may store information on a user who performs the interaction with the electronic apparatus 100. The user information may be used to identify a recognized user.

Further, the storing unit 150 may store information required to perform an operation using artificial intelligence, machine learning, and an artificial neural network. In the present specification, it is assumed that the processor 190 autonomously performs the machine learning or artificial neural network operation using models (for example, a gaze tracking model, a recognition model, and a reaction model) stored in the storing unit 150. As a selective embodiment, it is also implemented such that the external system 300 (see FIG. 1) performs the artificial intelligence, the machine learning, and the artificial neural network operation and the electronic apparatus 100 uses the operation result.

Hereinafter, the artificial intelligence, the machine learning, and the artificial neural network will be described for reference. Artificial intelligence (AI) is an area of computer engineering science and information technology that studies methods to make computers mimic intelligent human behaviors such as reasoning, learning, self-improving, and the like.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections and acquire problem-solving capability as the strengths of synaptic interconnections are adjusted throughout training. The terms ‘artificial neural network’ and ‘neural network’ may be used interchangeably herein.

An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a previous layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein. In general, a single-layer neural network may include an input layer and an output layer. In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights). Selectively, bias may be additionally summed and if this sum exceeds a threshold value of a corresponding neuron, the neuron can be activated and output an output value obtained through an activation function.

A deep neural network with a plurality of hidden layers between the input layer and the output layer may be the most representative type of artificial neural network which enables deep learning, which is one machine learning technique. In the meantime, the term “deep learning” may be used interchangeably with the term “deep training”.

The ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data. Throughout the present specification, an artificial neural network trained using training data may be referred to as a trained model.

Hereinbelow, learning paradigms of an artificial neural network will be described in detail. Learning paradigms, in which an artificial neural network operates, may be classified into supervised learning, unsupervised learning, semi-supervised learning, and reinforcement learning.

Supervised learning is a machine learning method that derives a single function from the training data. Among the functions that may be thus derived, a function that outputs a continuous range of values may be referred to as a regressor, and a function that predicts and outputs the class of an input vector may be referred to as a classifier. In supervised learning, an artificial neural network can be trained with training data that has been given a label.

Here, the label may refer to a target answer (or a result value) to be guessed by the artificial neural network when the training data is inputted to the artificial neural network. Throughout the present specification, the target answer (or a result value) to be guessed by the artificial neural network when the training data is inputted may be referred to as a label or labeling data. Throughout the present specification, assigning one or more labels to training data in order to train an artificial neural network may be referred to as labeling the training data with labeling data. Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data. Examples of unsupervised learning include, but are not limited to, clustering and independent component analysis. Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other. The generator may be a model generating new data that generates new data based on original data.

The discriminator may be a model recognizing patterns in data that determines whether inputted data is from the original data or from the new data generated by the generator. Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the original data and the data generated by the generator.

Referring to FIG. 2 again, the storing unit 150 may store an operating source code related to the recognition model 151 and an operating source code related to the reaction model 153.

Here, the recognition model 151 may be information required to recognize the user and may be loaded in a memory and used for the operation by the processor 190 when the user is directly recognized by the camera 121 or the user is recognized from an image photographed by the camera 121.

Further, the reaction model 153 may be loaded in the memory and used for the operation by the processor 190 to determine the interaction command for the user. When the user shows a specific reaction, the reaction model 153 may be used to determine the meaning or the motion.

Here, the interaction command is a command to perform an interaction with the user and may be a command which triggers an operation of the electronic apparatus 100 itself to interact with the user and may include an operation command to communicate with an external system 300 (see FIG. 1) as a selective or additional embodiment.

Further, the storing unit 150 may include a gaze tracking model (not illustrated) which accurately tracks the user' gaze through the camera 121. The processor 190 may load a source code corresponding to each model in the memory to perform the processing.

The power supply unit 160 is applied with external power and internal power to supply the power to each component of the electronic apparatus 100, under the control of the processor 190. The power supply unit 160 includes a battery and the battery may be an embedded battery or a replaceable battery. The battery may be charged by a wired or wireless charging method and the wireless charging method may include a magnetic induction method or a magnetic resonance method.

The processor 190 is a module which controls the components of the electronic apparatus 100. The processor 190 may refer to a data processing device embedded in hardware which has a physically configured circuit to perform a function expressed by a code or a command included in a program. Examples of the data processing device built in a hardware include, but are not limited to, processing devices such as a microprocessor, a central processing unit (CPU), a processor core, a multiprocessor, an application-specific integrated circuit (ASIC), a field programmable gate array (FPGA), and the like.

The processor 190 may recognize a reaction of the user and determine an interaction command for the user based on the recognized user's reaction and perform the determined interaction command. As a selective embodiment, the user may be replaced with an animal, a robot, or the like. The user's reaction may include a gaze, a facial expression, and a motion, but may also include other things such as a movement or an emotion which can be recognized by the camera 121.

Specifically, the processor 190 may track the gaze of the user through the camera 121. The processor 190 may track the gaze of the user using the camera 121 in real time and as a selective embodiment, photograph the gaze of the user using the camera 121 and track the gaze of the user from the photographed image. That is, the processor 190 may recognize the gaze of the user.

Further, the processor 190 may determine an interaction command based on the reaction of the user photographed by the camera 121. When the electronic apparatus 100 is a display device, if the gaze of the user is focused on a specific area of the displayed contents for a predetermined time period, the processor 190 may recognize a user's eye-frowned facial expression or a motion to approach the specific area. The predetermined time period may be determined as several seconds, but the exemplary embodiment is not limited thereto. Further, the facial expression and the motion may be implemented in various forms.

In this case, the processor 190 may determine an interaction command to enlarge and display a specific area based on the recognized facial expression or motion.

Further, when the gaze of the user is focused on the specific area of the contents for the predetermined time period, the processor 190 may recognize the motion of the user which indicates the specific area.

The processor 190 may determine an interaction command to display information related to the specific area on the display 141 based on the recognized motion.

Further, when the interaction command to display the information related to the specific area is determined, the processor 190 may divide the display 141 into a plurality of separate areas and control the display 141 to display the contents in a first separate area and display the information related to the specific area in a second separate area. Here, the number of divided screens may vary depending on the exemplary embodiment.

Further, the processor 190 may process and reconstruct the contents using information corresponding to the specific area of the contents stored in the storing unit 150 to provide the processed and reconstructed contents to the user.

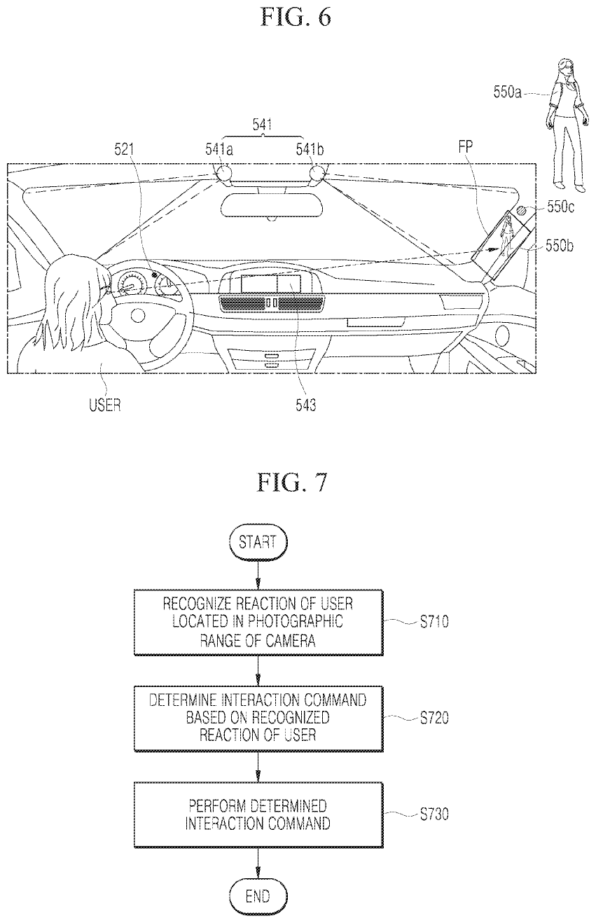

Hereinafter, an operation of the electronic apparatus 100 according to various exemplary embodiments of the present disclosure will be described with reference to FIGS. 3 to 6. In FIGS. 3 to 5, the electronic apparatus 100 will be described as a display device and in FIG. 6, the electronic apparatus will be described as an electronic apparatus mounted in a vehicle.

Referring to FIG. 3, the electronic apparatus 100 may include a camera 121 to photograph a user.

The electronic apparatus 100 may display a predetermined image (for example, an image for introducing a character in a movie) on the display 141. Here, the electronic apparatus 100 may display a specific character 320 on the display 141 and display a specific sentence 310a on the display 141.

Since the user USER may not recognize the specific sentence 310a, the user may frown while looking at the specific sentence 310a. Specifically, the user USER may frown the muscle around the eye (330, USER FACE). Further, the user USER may utter a voice “I cannot see it well”.

The electronic apparatus 100 may determine the interaction command which may be performed based on at least one of the gaze, the facial expression, and/or the motion of the user USER which are photographed while monitoring the user USER with the camera 121. Specifically, the processor 190 (See FIG. 2) of the electronic apparatus 100 may control the display 141 to enlarge (zoom-in) the specific sentence 310b to be displayed on the display 141. As a selective embodiment, the processor 190 may control the display 141 to enlarge the specific sentence 310a in the vicinity of the specific character 320.

The processor 190 may determine the interaction command by considering not only the gaze of the user, but also the facial expression and/or the motion. For example, when the user USER focuses the gaze on the specific area and the processor recognizes a motion to approach the specific area, the processor 190 may control the display 141 to enlarge and display the specific area based on the recognized motion.

When the processor 190 recognizes the user USER, the processor 190 may recognize the user USER using a (user) recognition model 151 stored in the storing unit 150. For example, the processor 190 may specify and recognize the user USER from the image based on the recognition model 151 generated by supervised learning or unsupervised learning. As a selective embodiment, the recognition model 151 may include a computer program required to perform various neural network algorithms and machine learning.

Further, the processor 190 may determine the interaction command of the recognized user USER based on the (user) reaction model 153. That is, the processor 190 may determine the interaction command based on the (user) reaction model 153 generated by the supervised learning or the unsupervised learning. Therefore, the processor 190 may determine a user-customized interaction command corresponding to a specific reaction. As a selective embodiment, the reaction model 153 may include a computer program required to perform various neural network algorithms and machine learning.

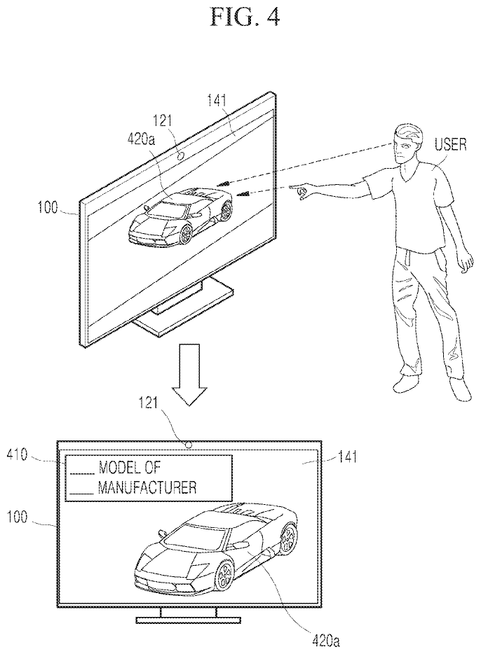

Referring to FIG. 4, the electronic apparatus 100 may include a camera 121 to photograph a user USER. The electronic apparatus 100 may track the gaze of the user USER and in some implemented examples, a gaze tracking model is stored in the storing unit 150 and loaded in the memory so that the operation may be performed by the processor 190 (See FIG. 2) of the electronic apparatus 100.

The processor 190 may output the contents to the display 141 and obtain the contents from the external system 300 or the storing unit 150. The obtained information may be implemented in various forms.

When the user's gaze stays in a specific area 420a of the contents for a predetermined time period and the user USER performs a motion indicating the specific area 420a of the contents (by a finger or a pointer), the processor 190 may set a command to interact with the user USER.

Specifically, the processor 190 may display manufacturer information and model name information 410 which are information related to the specific area 420a in one area beside the specific area 420a of the contents.

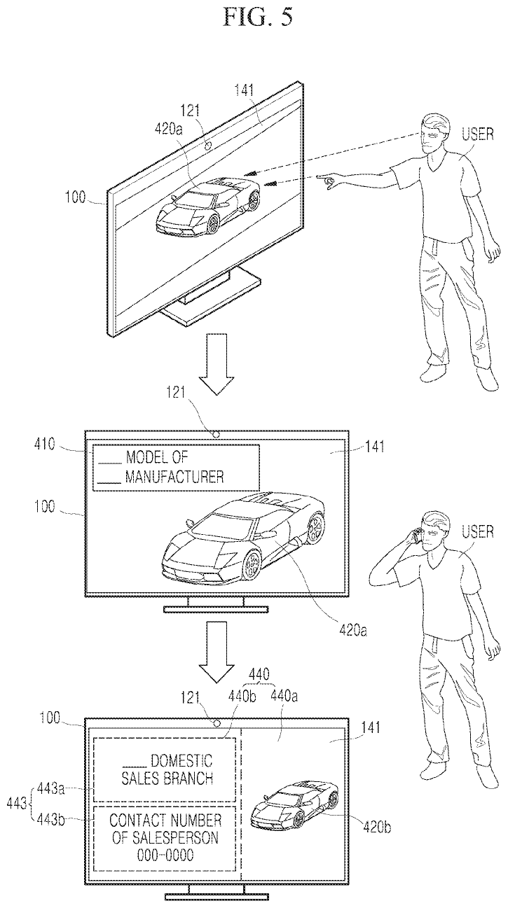

Referring to FIG. 5, when the user's gaze stays in the specific area 420a of the contents for a predetermined time period and the user USER indicates the specific area, the processor 190 (See FIG. 2) of the electronic apparatus 100 determines the interaction command to display information related to the specific area 420a (or an item displayed in the specific area).

Similar to FIG. 4, specifically, the processor 190 may display manufacturer information and model information 410 of a product displayed in the specific area 420a on the display 141.

As a selective embodiment, the processor 190 may virtually divide an area of the display 141 and display a specific area of the contents in a first divided separate area and display information related to the specific area in a second divided separate area.

Moreover, when the user USER performs a motion to make a phone call, the processor 190 may recognize it through the camera 121. In this case, the processor 190 may display purchase information related to the product displayed in the specific area 420b in the second separate area 440b. Here, the purchase information may include product sales branch information 443a and contact information 443b of a salesperson in charge.

Referring to FIG. 6, the electronic apparatus 100 (200 of FIG. 1) may be mounted in a vehicle. The electronic apparatus 100 may include an electric control unit ECU in the vehicle, an AVN module equipped with a display 543, and a projector 541 which projects an image into a so-called ‘A pillar’ i.e. a front pillar FP disposed at the front among pillars which connect a body of the vehicle and a top roof. The electronic apparatus 100 may include all components of the electronic apparatus illustrated in FIG. 2.

First, a first camera 521 is a module which photographs the user USER and may be disposed in a cluster in which a speed odometer and a dashboard are disposed and the projector 541 may be disposed each 541a and 541b at both sides of an overhead console.

Further, the electronic apparatus 100 further includes a second camera (not illustrated) which photographs the outside of the vehicle to recognize pedestrians and obstacles (for example, objects or vehicles) disposed in a blind spot when the vehicles turn or change the lanes.

The processor 190 of the electronic apparatus 100 may determine an interaction command based on at least one of a gaze, a facial expression and/or a motion of the user USER photographed by the first camera 521 and perform the determined interaction command.

Specifically, when the gaze of the user USER is focused on the front pillar area FP in the vehicle during a predetermined time period, the processor 190 may photograph the outside of the vehicle corresponding to the front pillar area FP by means of the second camera.

When the processor 190 recognizes the pedestrian 550a or the obstacle at the outside of the vehicle which is photographed, the processor 190 may determine an interaction command to display visualization information on the pedestrian 550a or the obstacle in the front pillar area FP. The visualization information may include a shape representing the pedestrian 550a or the obstacle at the outside and/or a warning element 550c. That is, the processor 190 may display an image of the outside of the vehicle corresponding to the front pillar area FP in the front pillar area FP. Accordingly, the accident of the autonomous vehicle or a driver's vehicle may be prevented in advance.

Further, the processor 190 may generate area information in which traffic is congested and area information in which accidents frequently occur as model information, based on information such as vehicle usage time information of the user USER, driver habit information, and a high frequently used route, to store the information in the storing unit 150. As a selective embodiment, the model information may be generated by the external system 300 (see FIG. 1) to be stored in the external system 300.

Further, before photographing the outside of the vehicle corresponding to the front pillar area FP, a left or right direction indicator light corresponding to the front pillar area FP may be activated. That is, when the vehicle makes the left turn/right turn or changes the lane, the processor 190 may apply the above-described function to the electronic apparatus 100.

FIG. 7 is a sequence diagram illustrating an operating method of an electronic apparatus 100 according to an exemplary embodiment of the present disclosure.

The electronic apparatus 100 recognizes the reaction of the user located in the photographic range of the camera in step S710.

The electronic apparatus 100 may monitor the camera in real time to track the gaze of the user. As a selective embodiment, the electronic apparatus 100 may track the gaze of the user from the image obtained by photographing the gaze of the user.

In this case, the electronic apparatus 100 may calculate a distance from the user using a distance sensing sensor. The electronic apparatus 100 may detect the point where the gaze of the user stays from the photographed image and as a selective embodiment, the electronic apparatus 100 may track a photographic focus of the camera to detect the point where the gaze of the user stays.

Further, the electronic apparatus 100 may recognize the facial expression and the motion of the user using the camera.

Thereafter, the electronic apparatus 100 determines an interaction command based on the recognized reaction of the user in step S720.

The electronic apparatus 100 may determine the interaction command for the user based on at least one of the tracked gaze, facial expression, or motion of the user.

Finally, the electronic apparatus 100 may perform the determined interaction command in step S730.

Further, the operating method of the electronic apparatus 100 may further include recognizing the photographed user based on a previously stored recognition model. Here, the recognition model may include information required to recognize the user from the photographed image.

The step S720 may further include determining the interaction command for the recognized user based on a previously stored reaction model. The reaction model has been described above in detail so that a specific description will be omitted.

When the electronic apparatus 100 is a display device, the operating method of the electronic apparatus 100 may further include displaying predetermined contents before the step S710. In this case, the following two exemplary embodiments may be applied.

First, the operating method of the electronic apparatus 100 may further include recognizing an eye-frowned facial expression of the user or a motion to approach the specific area when the gaze of the user is focused on a specific area of the contents for a predetermined time period.

In this case, the electronic apparatus 100 may determine an interaction command to enlarge and display a specific area based on the recognized facial expression or motion.

Second, the operating method of the electronic apparatus 100 may further include recognizing a motion of the user which indicates a specific area when the gaze of the user is focused on a specific area of the contents for a predetermined time period.

In this case, the electronic apparatus 100 may determine an interaction command to display information related to a specific area based on the recognized motion.

The electronic apparatus 100 may virtually divide the display. Specifically, when the interaction command to display the information related to the specific area is determined, the electronic apparatus 100 may divide the display area into a plurality of separate areas and display contents in a first separate area and display information related to the specific area in a second separate area.

Here, when the information related to the specific area is displayed in the second separate area, if the user additionally performs a motion to make a phone call, the electronic apparatus 100 may display purchase information related to a product displayed in the specific area in the second separate area.

Further, when an item on which the gaze of the user stays is within a photographic range of the camera, the electronic apparatus 100 may focus the item to be zoomed in or out. Therefore, the user may more closely look at the focused contents. In this case, even though the electronic apparatus is not necessarily a display device, the contents may be focused.

The electronic apparatus 100 may be mounted in a vehicle. In this case, the step S720 of the operating method of the electronic apparatus 100 may include photographing the outside of the vehicle corresponding to the front pillar area when the tracked gaze of the user is focused on the front pillar area in the vehicle during a predetermined time period and determining an interaction command to display information related to a pedestrian or an obstacle in the front pillar area when the pedestrian or the obstacle located at the outside of the vehicle is recognized.

The above-described present disclosure may be implemented in a program-recorded medium by a computer-readable code. The computer-readable medium includes all types of recording devices in which data readable by a computer system is stored. Examples of the computer-readable medium may include a hard disk drive (HDD), a solid state disk (SSD), a silicon disk drive (SDD), ROM, RAM, CD-ROM, a magnetic tape, a floppy disk, an optical data storage device, and the like. Further, the computer may include the processor 190 of the electronic apparatus 100.

Although a specific embodiment of the present invention has been described and illustrated above, the present invention is not limited to the described embodiment and it is understood by those skilled in the art that the present invention may be modified and changed in various specific embodiments without departing from the spirit and the scope of the present invention. Therefore, the scope of the present invention is not determined by the described embodiment but may be determined by the technical spirit described in the claims.

What is claimed is:

1. An operating method of an electronic apparatus, the operating method comprising:
recognizing at least one of a gaze, a facial expression, or a motion of a user located in a photographic range of a camera;
determining an interaction command for the user based on at least one of the recognized gaze, facial expression, or motion of the user; and
performing the determined interaction command.

2. The operating method of an electronic apparatus according to claim 1, further comprising:
recognizing the photographed user based on a previously stored recognition model,
wherein the determining of an interaction command includes:
determining an interaction command for the user in accordance with a previously stored reaction model, based on at least one of the recognized gaze, facial expression, or motion of the user.

3. The operating method of an electronic apparatus according to claim 1, further comprising:
prior to the recognizing of at least one of a gaze, a facial expression, or a motion of the user, displaying predetermined contents.

4. The operating method of an electronic apparatus according to claim 3, wherein the recognizing includes:
recognizing an eye-frowned facial expression of the user or a motion to approach the specific area when the gaze of the user is focused on the specific area of the contents for a predetermined time period, and
the determining of an interaction command includes:
determining an interaction command to enlarge and display the specific area based on the recognized facial expression or motion.

5. The operating method of an electronic apparatus according to claim 3, wherein the recognizing includes:
recognizing a motion of the user which indicates the specific area when the gaze of the user is focused on the specific area of the contents for a predetermined time period, and
the determining of an interaction command includes:
determining an interaction command to display information related to the specific area based on the recognized motion.

6. The operating method of an electronic apparatus according to claim 5, wherein the performing of the determined interaction command includes:
dividing a display area into a plurality of separate areas when an interaction command to display information related to the specific area is determined; and
displaying the contents in a first separate area and displaying the information related to the specific area in a second separate area.

7. The operating method of an electronic apparatus according to claim 6, wherein the displaying of the information related to the specific area in the second separate area includes:
displaying purchase information related to a product displayed in the specific area in the second separate area.

8. The operating method of an electronic apparatus according to claim 1, wherein the determining of an interaction command includes:
photographing the outside of a vehicle corresponding to a front pillar area when the recognized gaze of the user is focused on the front pillar area in the vehicle for a predetermined time period; and
determining an interaction command to display an image of the outside of the vehicle corresponding to the front pillar area in the front pillar area.

9. The operating method of an electronic apparatus according to claim 8, further comprising:
prior to the photographing of the outside of the vehicle corresponding to the front pillar area, activating a left or right direction indicator light corresponding to the front pillar area.

10. An electronic apparatus, comprising:
a camera;
a display which displays predetermined contents; and
a processor which recognizes at least one of a gaze, a facial expression, or a motion of a user by means of the camera, determines an interaction command for the user based on at least one of the recognized gaze, facial expression, or motion of the user, and performs the determined interaction command.

11. The electronic apparatus according to claim 10, further comprising:
a storage which stores a recognition model to recognize a user and a reaction model to determine an interaction command for the recognized user.

12. The electronic apparatus according to claim 10, wherein the processor recognizes an eye-frowned facial expression of the user or a motion to approach the specific area when the gaze of the user is focused on the specific area of the contents for a predetermined time period, and determines an interaction command to enlarge and display the specific area based on the recognized facial expression or motion.

13. The electronic apparatus according to claim 10, wherein the processor recognizes a motion of the user which indicates the specific area when the gaze of the user is focused on the specific area of the contents for a predetermined time period, and determines an interaction command to display information related to the specific area on the display based on the recognized motion.

14. The electronic apparatus according to claim 13, wherein when the interaction command to display the information related to the specific area is determined, the processor divides the display into a plurality of separate areas and controls the display to display the contents in a first separate area and display the information related to the specific area in a second separate area.

15. The electronic apparatus according to claim 14, wherein the processor controls the display to display purchase information related to a product displayed in the specific area in the second separate area.

16. An electronic apparatus mounted in a vehicle, the electronic apparatus comprising:
a first camera which photographs a user located in the vehicle;
a second camera which photographs the outside of the vehicle; and
a processor which recognizes at least one of a gaze, a facial expression, or a motion of the user by means of the first camera, determines an interaction command based on at least one of the recognized gaze, facial expression, or motion of the user, and performs the determined interaction command,
wherein the processor photographs the outside of the vehicle corresponding to a front pillar area using the second camera when the gaze of the user is focused on the front pillar area in the vehicle for a predetermined time period; and determines an interaction command to display an image of the outside of the vehicle corresponding to the front pillar area in the front pillar area.
